(19) United States
(12) Patent Application Publication
(10) Pub. No.: US 2025/0056685 A1
(43) Pub. Date: Feb. 13, 2025

(54) PORTABLE BATTERY POWERED INDUCTION COOKTOP APPARATUS AND ELECTRIC LIQUID BOILING SYSTEMS

(71) Applicant: LectricBoil LLC, Detroit, MI (US)

(72) Inventors: Jarret A. Schlaff, Detroit, MI (US); Benjamin C. Moes, Caledonia, MI (US)

(73) Assignee: LectricBoil LLC, Detroit, MI (US)

(21) Appl. No.: 18/796,797

(22) Filed: Aug. 7, 2024

Related U.S. Application Data
(60) Provisional application No. 63/518,131, filed on Aug. 8, 2023.

(51) Int. Cl. H05B 6/06; A47J 36/24; H02J 7/35; H05B 6/12

(52) U.S. Cl. CPC H05B 6/062; A47J 36/2483; H02J 7/35; H05B 6/1209

(57) ABSTRACT

A portable battery-powered induction cooktop apparatus comprises: a cooktop comprising a cooking surface; a removable battery; an induction system connected to the removable battery, the induction system comprising: (i) an induction coil located adjacent to the cooking surface; and a (ii) controller comprising a circuit configured to facilitate power transfer from the removable battery to the induction coil; and a housing surrounding at least a portion of the induction system. A portable heating apparatus comprises: a container for a liquid to be heated; a removable battery; an induction system connected to the removable battery, wherein the induction system comprises: (i) an induction coil located adjacent to the vessel; and (ii) a controller, comprising a circuit configured to facilitate power transfer from the removable battery to the induction coil; a housing surrounding at least a portion of the induction system; and one or more solar panels connected to the removable battery.

### CROSS-REFERENCE TO RELATED PATENT APPLICATIONS

This application claims the benefit of priority under 35 U.S.C. § 119 (e) to U.S. Provisional Application No. 63/518,131, filed Aug. 8, 2023, which is incorporated herein by reference in its entirety.

### BACKGROUND

The following description of the background of the present technology is provided simply as an aid in understanding the present technology and is not admitted to describe or constitute prior art to the present technology.

The present disclosure relates generally to portable, induction cooktop systems. Portable induction cooktop systems offer several advantages in outdoor and off-grid settings. Induction cooking is highly efficient because it directly heats cookware via electromagnetic induction, affording faster heating times and precise temperature control, which is crucial in settings where resources like fuel may be limited. Accordingly, induction cooking poses a lower fire risk because it heats only the cookware, not the surrounding air or surfaces, which enhances safety in dry or windy outdoor conditions. Moreover, they are generally cleaner to operate than traditional fuel-based cooking systems due to the reduction or elimination of soot, ash, or residue compared to open-flame cooking methods. Further, induction cooking is more energy-efficient than traditional gas, charcoal, or other electric methods, contributing to lower carbon emissions and reduced environmental impact, which aligns with sustainable outdoor practices.

However, to date, there are few, if any, widely used practical examples of portable induction cooktops which are lightweight and compact enough to make them easy and convenient to transport and set up in outdoor environments. They often require direct connection to power systems, which reduces their flexibility. Thus, portable induction cooktop systems that are capable of being reliably operated using removable batteries rechargeable by portable power sources would be highly advantageous.

### SUMMARY

In one aspect, the present disclosure relates to a portable, battery-powered induction cooktop apparatus comprising: a cooktop comprising a cooking surface; a removable battery; an induction system connected to the removable battery, the induction system comprising: (i) an induction coil located adjacent to the cooking surface; and a (ii) controller, wherein the controller comprises a circuit configured to facilitate power transfer from the removable battery to the induction coil; a housing surrounding at least a portion of the induction system, wherein the housing comprises a lid configured to cover at least a portion of the cooktop. In some embodiments, the portable, battery-powered cooktop apparatus further comprises a user interface comprising a microprocessor configured to receive and analyze data from the removable battery; and a display connected to the microprocessor.

In some embodiments, the cooktop comprises two cooking surface induction coils.

In some embodiments, the removable battery is connected to one or more solar panels. In some embodiments, the one or more solar panels comprises a flexible solar panel. In some embodiments, the one or more solar panels has a charging rate of 40 W to 250 W.

In some embodiments, the apparatus further comprises adjustable feet. In some embodiments, the apparatus further comprises wind guards. In some embodiments, the apparatus further comprises a handle or a removable strap connected to the housing. In some embodiments, the lid comprises an integrated cutting board.

In some embodiments, the apparatus is capable of boiling 1 cup of water in 120 seconds or less, 100 seconds or less, 90 seconds or less, 75 seconds or less, or 60 seconds or less.

In some embodiments, the controller comprises a rotary encoder configured to permit a user to adjust output power of the removable battery.

In some embodiments, the removable battery has an input power of 40 W to 2500 W. In some embodiments, the removable battery has a capacity of 1500 W or a maximum power of up to 2500 W. In some embodiments, the removable battery is a solid-state battery. In some embodiments, the removable battery is connected to one or more AC ports or DC ports.

In some embodiments, the induction system comprises a wireless communication device.

In another aspect, which may be combined with any other aspect or embodiment, the present disclosure relates to a method for heating a food item or liquid using the apparatus of any of the embodiments disclosed herein, the method comprising: placing a vessel containing the food item or liquid adjacent to or in contact with the cooking surface; and operating the induction system to heat the food item or liquid. In some embodiments, the food item or liquid is water, and the operating heats the water at a rate sufficient to boil one cup of water in 90 seconds or less.

In another aspect, which may be combined with any other aspect or embodiment, the present disclosure relates to a portable heating apparatus, comprising: a container configured to contain a food item or liquid to be heated; a removable battery; an induction system connected to the removable battery, wherein the induction system comprises: (i) an induction coil located adjacent to the vessel; and (ii) a controller, wherein the controller comprises a circuit configured to facilitate power transfer from the removable battery to the induction coil; a housing surrounding at least a portion of the induction system; and one or more solar panels connected to the removable battery.

In some embodiments, the vessel is thermally insulated.

In some embodiments, the battery is a solid-state battery.

In some embodiments, the one or more solar panels are configured to retract into the housing.

Additional aspects and/or embodiments of the invention will be provided, without limitation, in the detailed description of the present technology set forth below. The following detailed description is exemplary and explanatory, but it is not intended to be limiting.

### BRIEF DESCRIPTION OF THE DRAWINGS

Various objects, aspects, features, and advantages of the disclosure will become more apparent and better understood by referring to the detailed description taken in conjunction with the accompanying figures.

FIG. 1 is an exploded perspective view of the cooktop apparatus according to one embodiment of the present disclosure.

FIG. 2 is an elevated view of a cooktop apparatus according to one embodiment of the present disclosure, wherein the cover is open.

FIG. 3 is an elevated view of a cooktop apparatus according to one embodiment of the present disclosure, wherein the cover is closed.

FIG. 4 is a side view of the cooktop apparatus according to one embodiment of the present disclosure, wherein the cover is open.

FIG. 5 is a back view of the cooktop apparatus according to one embodiment of the present disclosure, wherein the cover is open.

FIG. 6 is a block diagram of a power management system for operating an induction cooktop system according to an embodiment of the present disclosure.

FIG. 7 is a block diagram of a power management system for operating an induction cooktop according to an embodiment of the present disclosure.

FIG. 8 is a block diagram of a power management system for operating an induction cooktop according to an embodiment of the present disclosure.

FIG. 9 is a block diagram of a power management system for operating an induction cooktop according to an embodiment of the present disclosure, showing an embodiment of a graphical display providing system information.

FIG. 10 is a top-down schematic of an airflow system for cooling an induction cooktop apparatus according to an embodiment of the present disclosure.

FIG. 11 is a side-view schematic of a battery pack according to an embodiment of the present disclosure, showing power inputs and USB connectors.

FIG. 12 is a functional block diagram showing two separate printed circuit board layouts within a battery pack according to the present disclosure.

FIG. 13 is an exploded perspective view of a portable heating apparatus according to one embodiment of the present disclosure.

### DETAILED DESCRIPTION

### Portable Cooktop Apparatus

In one aspect, the present disclosure relates to a portable, battery-powered induction cooktop apparatus (hereinafter “cooktop apparatus”). In some embodiments, the cooktop apparatus comprises a removable battery, which may be charged using various power sources (e.g., solar panels), which may reduce carbon emissions into the environment.

### Cooking Surface

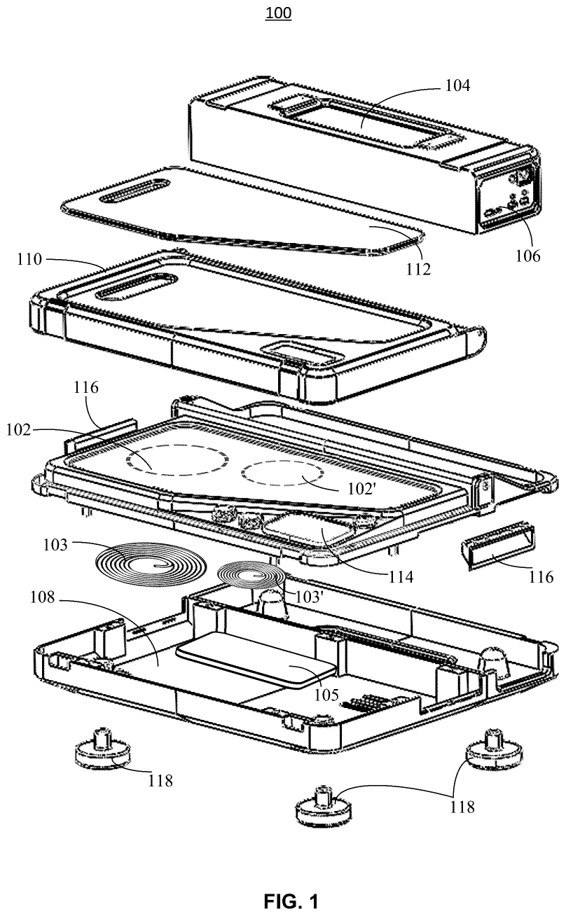

Referring now to FIG. 1, a cooktop apparatus 100 according to the present disclosure comprises a cooking surface 102 where a container (e.g., induction cookware) may be placed to position it in proximity to an induction coil 103, such that the induction coil 103 is able to induce sufficient electric current in the container to heat it. The cooking surface may be disposed directly above the induction coil in a direction substantially orthogonal to the plane in which the induction coil lies. In some embodiments, the cooktop apparatus 100 includes two cooking surfaces 102, 102′, each corresponding to an induction coil 103, 103′, respectively. The cooking surfaces 102, 102′ may comprise any suitable heat-resistant, electrically insulating material (e.g., ceramic, glass, glass-ceramic (e.g., NEOCERAM™), stone, quartz, heat-resistant polymers, polymer composites, fiberglass, or combinations thereof).

The cooking surfaces 102 may be any suitable shape for accommodating induction cookware and guiding the user to place the cookware in proximity to an induction coil 103, such that the induction coil 103 is able to induce sufficient electric current in the cookware to heat it. Although not intended to be limiting, the cooking surface 102 may be circular, square, rectangular, or polygonal in shape. In embodiments comprising more than one cooking surface 102, the cooking surfaces 102 may be equal to one another or may vary in size. In some embodiments, the cooktop apparatus 100 comprises two circular cooking surfaces 102. In some embodiments, the cooktop apparatus 100 comprises a first cooking surface 102, which is circular in shape and has a diameter of 4 to 18 inches (e.g., 4, 5, 6, 7, 8, 9 10, 11, 12, 13, 14, 15, 16, 17, or 18 inches) and a second cooking surface 102′ which is circular in shape and has a diameter of 4 to 18 inches (e.g., 4, 5, 6, 7, 8, 9 10, 11, 12, 13, 14, 15, 16, 17, or 18 inches). In some embodiments, the cooktop apparatus 100 comprises a first cooking surface 102, which is circular and has a diameter of about 10 inches, and a second cooking surface 102′, which is circular and has a diameter of about 6 inches. Other configurations and combinations of numbers, shapes, and sizes of cooking surfaces 102 will be apparent to persons having ordinary skill in the art.

### Removable Battery Pack

Referring still to FIG. 1, the cooktop apparatus 100 may include a removable battery pack 104 configured to power the cooktop apparatus 100. Although not intended to be limiting, in some embodiments, the removable battery pack 104 is removably coupled to the cooking surface 102 or other components of the cooktop apparatus 100. The removable battery pack 104 may comprise a lithium-ion battery. In some embodiments, the removable battery pack 104 may comprise a lithium-iron phosphate (LiFePO₄) battery, lithium manganese oxide (LiMn₂O₄) battery, lithium nickel manganese cobalt oxide (NMC) battery, lithium nickel cobalt aluminum oxide (NCA) battery, lithium titanate (LTO) battery, or sodium-iron-phosphate battery. In some embodiments, the removable battery pack 104 is a solid-state battery or a lead-acid battery.

In some embodiments, the removable battery pack 104 may include a 48V 20 Ah 1 kWHr capacity with 55-amp continuous current and 60-amp peak current.

The removable battery pack 104 may provide any suitable output power to one or more induction coils. In some embodiments, the removable battery has an output power of 40 W to 2500 W, 100 W to 2000 W, 200 W to 1500 W, 400 W to 1000 W, 400 W to 800 W, 500 W to 1000 W. In some embodiments, the removable battery pack 104 may have a power output of about 400 W, about 500 W, about 600 W, about 700 W, about 800 W, about 900 W, about 1000 W, about 1100 W, about 1200 W, about 1300 W, about 1400 W, about 1500 W, about 2000 W, or any range or value including and/or between any two of these values.

In some embodiments, the removable battery pack 104 has a maximum power of less than or equal to about 2500 W, less than or equal to about 2400 W, less than or equal to about 2300 W, less than or equal to about 2200 W, less than or equal to about 2100 W, less than or equal to about 2000 W, less than or equal to about 1900 W, less than or equal to about 1800 W, less than or equal to about 1700 W, less than or equal to about 1600 W, less than or equal to about 1500 W, or any range or value including and/or between any two of these values. In some embodiments, the removable battery pack 104 has a maximum power of greater than or equal to about 1000 W, greater than or equal to about 1000 W, greater than or equal to about 1100 W, greater than or equal to about 1200 W, greater than or equal to about 1300 W, greater than or equal to about 1500 W, greater than or equal to about 1600 W, greater than or equal to about 1700 W, greater than or equal to about 1800 W, greater than or equal to about 1900 W, greater than or equal to about 2000 W, greater than or equal to about 2100 W, greater than or equal to about 2200 W, greater than or equal to about 2300 W, greater than or equal to about 2400 W, greater than or equal to about 2500 W, or any range or value including and/or between any two of these values.

In some embodiments, the removable battery pack 104 may operate for at least 500 cycles, at least 600 cycles, at least 700 cycles, at least 800 cycles, at least 900 cycles, or at least 1000 cycles before replacement. In some embodiments, the removable battery pack 104 may keep memory of the charge and discharge cycles. The cooktop apparatus 100 may recommend the user via a user interface to replace the removable battery pack 104 if the battery cannot reliably hold charge based on a predetermined threshold. In some embodiments, the cooktop apparatus 100 may identify each unique battery cell and record the charge and discharge cycles on memory within the removable battery pack 104 itself.

In some embodiments, the removable battery pack 104 may include a high-power battery charging IC (e.g., the BQ25756 from Texas Instruments) configured to manage input power of the cooktop apparatus 100. In some embodiments, the IC may receive power from additional ports 106 connected to the removable battery pack 104. The additional ports 106 may include one or more of a rectified AC, solar panel input, 12 V DC, and/or USB port. The additional ports 106 may transmit energy to a voltage converter inside the removable battery pack 104 to charge the battery pack 104.

In some embodiments, the removable battery pack 104 is configured to charge with external devices (e.g., solar panels). For example, the cooktop apparatus 100 may be powered to operate with solar panels, exterior renewable energy generators, 110 V electrical outlets, or 12 V vehicle outlets. In some embodiments, the removable battery pack 104 may be removed from the cooktop apparatus 100 to serve as a mobile power bank. For example, the removable battery pack 104 may be capable of charging and/or powering external electronic devices, outdoor recreation accessories, or other similar products.

Although some embodiments use a removable battery pack 104, in additional embodiments, the battery pack is not removable.

### Solar Panels

The cooktop apparatus 100 may include one or more solar panels removably coupled to the removable battery pack 104 to supply power to the system. The cooktop apparatus 100 may include rigid, flexible, or a combination of rigid and flexible solar panels. For example, the cooktop apparatus 100 may include rigid solar panels including, but not limited to, monocrystalline silicon solar panels, polycrystalline silicon solar panels, amorphous silicon (a —Si) solar panels, cadmium telluride (CdTe) solar panels, copper indium gallium selenide (CIGS) solar panels, or any combination thereof. In some embodiments, the solar panels comprise flexible solar panels such as a-Si flexible solar panels, CIGS flexible solar panels, organic photovoltaic (OPV) flexible solar panels, perovskite flexible solar panels, thin-film crystalline silicon flexible solar panels, or any combination thereof.

In some embodiments, the solar panels have a power rating of about 40 W to about 400 W, about 50 W to about 200 W, about 100 W to about 150 W, or any range or value including and/or between any two of these values. In some embodiments, the solar panels have a power rating of at least about 40 W, at least about 50 W, at least about 60 W, at least about 70 W, at least about 80 W, at least about 90 W, at least about 100 W, 110 W, at least about 120 W, at least about 130 W, at least about 140 W, at least about 150 W, at least about 160 W, at least about 170 W, at least about 180 W, at least about 190 W, at least about 200 W, at least about 210 W, at least about 220 W, at least about 230 W, at least about 240 W, at least about 250 W, at least about 300 W, at least about 350 W, at least about 400 W, or any range or value including and/or between any two of these values. In some embodiments, the solar panels may have a total weight from about 5 lbs. to about 30 lbs.

### Induction System

Referring still to FIG. 1, the cooktop apparatus 100 comprises an induction system connected to the removable battery pack 104. The induction system comprises an induction coil 103 and a controller 105 configured to facilitate power transfer from the removable battery pack 104 to the induction coil 103. The induction system may include additional components such as one or more fans, one or more heat sinks, or other heat dissipation devices to improve the performance of the cooktop apparatus 100.

### Induction Coil

A cooktop apparatus 100 according to the present disclosure comprises an induction coil 103 located adjacent to the cooking surface 102. In some embodiments, the induction coil 103 comprises copper. In some embodiments, the induction coil 103 comprises ferrite materials to enhance electromagnetic field generation and reduce eddy current losses. In some embodiments, the ferrite materials comprise “soft” ferrite materials comprising manganese-zinc (MnZn) or nickel-zinc (NiZn) compounds. In some embodiments, laminated iron or steel sheets may be used in conjunction with ferrite materials to promote and/or enhance magnetic field generation. In some embodiments, the induction coil comprises an electrically insulating and/or thermally insulating coating comprising, e.g., a ceramic, a glass, a high-temperature resistant polymer (e.g., a polyimide) to provide electrical insulation for the coil and prevent short circuits. In some embodiments, the cooktop apparatus 100 comprises two or more induction coils 103.

### Controller

The induction system comprises a controller 105 to control power supply from the battery to the induction coil 103. In some embodiments, the controller 105 comprises a circuit configured to facilitate power transfer from the removable battery pack 104 to the induction coil 103. The circuit of the controller 105 may include one or more processors configured to control and/or monitor the battery. The processor(s) may be or include any device, component, element, or hardware designed or configured to perform the various steps recited herein. For example, the processor(s) may include any number of general-purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof, designed or configured to perform the various steps recited herein. In some embodiments, the processor(s) may be coupled to memory configured to store data for system processing and performance. In some embodiments, the circuit comprises one or more sensors configured and/or arranged to sense various conditions of the cooktop apparatus 100. For example, in some embodiments, the sensor(s) may include any number of voltage sensors, current sensors, temperature sensors, cookware detection sensors (e.g., inductive or capacitive sensors), position and/or proximity sensors (e.g., capacitive touch or infrared proximity sensors), load sensors, or any combination thereof configured or arranged to sense various conditions recited herein.

The controller 105 may facilitate power transfer from the removable battery pack 104 to the induction coil 103 using the one or more processors, memory, or one or more sensors of the circuit. For example, the controller 105 may communicate with the removable battery pack 104 to increase or decrease power output to the induction coil to achieve a desired temperature set on the cooktop apparatus 100. The temperature sensors of the circuit (e.g., a thermocouple) may transmit a temperature reading of the cooking surface 102, induction coil 103, or the air or surfaces disposed near the cooking surface(s) or induction coil(s), to the controller 105. The controller 105 then via the one or more processors may prompt the charging module to adjust power output according to the desired temperature. As another example, the controller 105 may include a circuit configured to automatically turn off power to the cooktop apparatus 100 after remaining idle for a designated period. In some embodiments, the controller 105 may include a circuit configured to complete actions such as calibrate the power output of the removable battery pack 104 or induction coil 103, immediately shut of the system fan(s), reduce noise after the system reaches a set decibel level, and other functions.

### Housing

Referring still to FIG. 1, the cooktop apparatus 100 comprises a housing 108 disposed at least below the cooking surfaces and surrounding at least a portion of the induction system. The housing 108 provides an insulative barrier to protect the user from the electrically conductive and thermally conductive internal components. The housing 108 also mitigates the introduction of dust or debris that may damage the components of the cooktop apparatus 100. Moreover, the housing 108 serves to contain the components of the cooktop apparatus 100 in a manner that permits easy transportation and use without the need for assembly on site.

In some embodiments, the cooktop apparatus 100 comprises a lid 110 configured to cover at least a portion of the cooking surface 102 to protect the system components from physical damage and environmental contaminants. The lid 110 may attach to the housing 108 via any suitable component (e.g., one or more hinges). In some embodiments, the housing 108 and/or lid 110 comprises lightweight, durable materials such as stainless steel, aluminum, powder-coated steel, ceramic-coated metals, cast iron, heat-resistant polymers, composite materials, and other durable materials. In some embodiments, the lid 110 accommodates a removable cutting board 112 to facilitate meal preparation. The cutting board 112 may be held in place in the lid by any suitable mechanism (e.g., one or more detents, clips, straps, or magnets, etc.). The cutting board 112 may be accommodated within a recess within the lid 110.

In some embodiments, the cooktop apparatus 100 comprises one or more handles 116 to facilitate easy transport of the cooktop apparatus 100. The handles may be rigid and may be composed of any material suitable for the housing 108 (e.g., plastic, metal, wood, or ceramic material), as disclosed herein. Still referring to FIG. 1, in some embodiments, the cooktop apparatus 100 may include handles 116 connected to the lateral sides of the system.

In some embodiments, the cooktop apparatus 100 comprises adjustable feet 118 capable of being adjusted to various heights to permit level placement of the cooktop apparatus 100 on uneven surfaces. The adjustable feet 118 may extend in an axial direction to stabilize the cooktop apparatus 100. In some embodiments, an adjustable strap may be added to the lateral sides to enhance portability. In some embodiments, the cooktop apparatus 100 may comprise a leveling tool (e.g., a bubble level embedded in the housing) to assist users in leveling the cooktop apparatus 100 on uneven surfaces.

In some embodiments, the cooktop apparatus 100 may be compatible with a griddle plate attachment placed onto the cooking surface. The griddle plate attachment may lock in place directly on top of the cooking surface 102, or there may be a space between the griddle top and the cooking surface 102 via stabilizing legs. Additional cooking surface options such as the griddle attachment may allow users to prepare additional types of meals without need of appliances like pots, pans, or other similar devices.

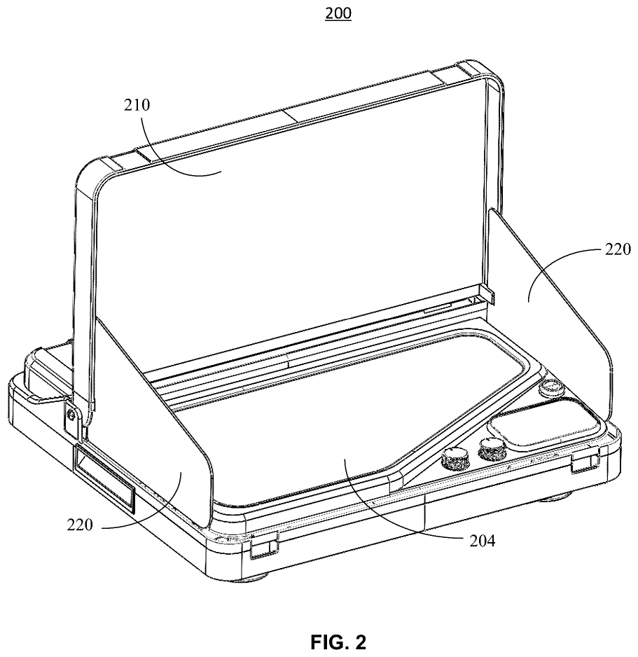

Referring now to FIG. 2 through FIG. 5, various orientations of the cooktop apparatus are shown, demonstrating various features of the cooktop apparatus. FIG. 2 demonstrates the cooktop apparatus 200 with wind guards 220 in the open position. The cooktop apparatus 200 may comprise wind guards 220 configured to retract on the lateral sides of the cooking surface 202 or configured to rotate onto the cooking surface 202 or into the lid 210 (e.g., via one or more hinges) when the cooking surface is not in use. The wind guards 202 may shield the cooking surface from the wind and improve heating efficiency. The wind guards 202 may also protect the electronic components of the cooktop apparatus 200 from dust, debris, and moisture from the environment.

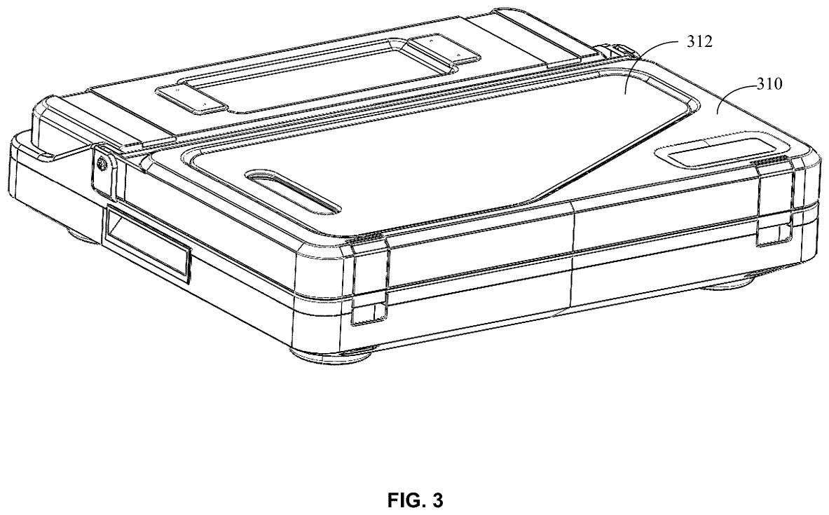

FIG. 3 further demonstrates the synergistic housing of the removable cutting board 302 in the closed orientation of the cooktop apparatus 300. The lid 310 of the cooktop apparatus 300 may comprise a recessed region that matches the shape of the removable cutting board 312 to secure the components in place during transport.

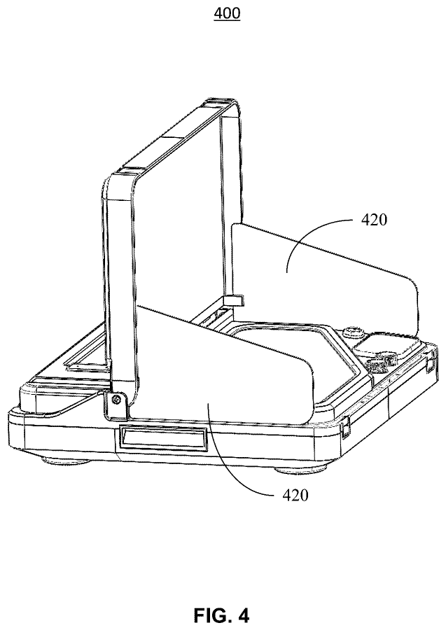

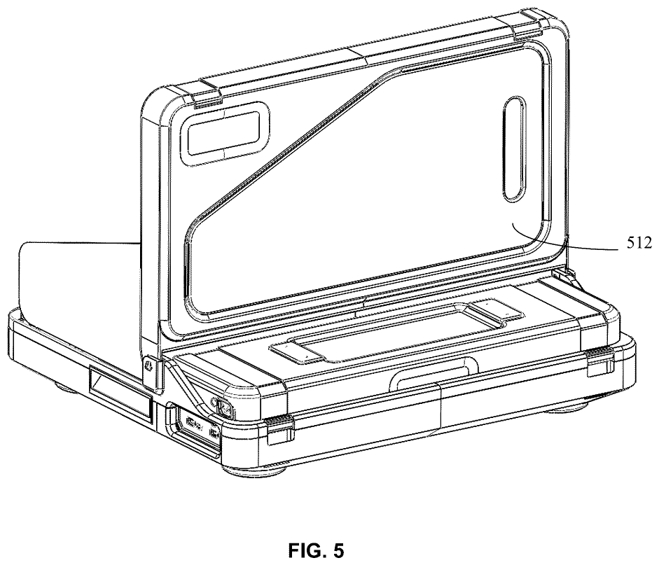

FIG. 4 further demonstrates the wind guard placement in the view of the cooktop apparatus 400. FIG. 5 further demonstrates the stabilization of the removable cutting board 512 in the lid 510 of the cooktop apparatus 500 when in the open orientation.

### User Interface & Display

Referring still to FIG. 1, in some embodiments, the cooktop apparatus 100 comprises a user interface 114 configured to receive and display data about the cooktop apparatus 100 and induction system (e.g., output power from the battery; battery life remaining; temperature near the induction coil; power output distribution to multiple cooking surfaces; presence of cookware on one or more cooking surfaces, etc.). In some embodiments, the user interface 114 may include a microprocessor to interpret power and data obtained from sensors (e.g., temperature or moisture sensors). In some embodiments, the user interface 114 may include a touchscreen display to allow users to directly select options (e.g., cooking surface power, set temperature, cook time, etc.) by interacting with the screen. In some embodiments, the display comprises a resistive touchscreen, a capacitive touchscreen, or an infrared touchscreen to receive inputs from the user. In some embodiments, the display comprises an LCD, LED, or OLED screen to display outputs or receive inputs from the user.

In some embodiments, the user interface 114 comprises tactile buttons or rotary encoders to adjust power output of the induction coil associated with a cooking surface. For example, the user interface 114 may include one or more tactile buttons configured to turn the system on and off. As another example, the user interface 114 may include rotary encoders configured to adjust temperature, switch between different menus or displays, and select additional feature settings of the cooktop apparatus 100. The rotary encoders may convert rotational position or motion into a digital signal, which may allow users to quickly scroll through system options. In some embodiments, the user interface 114 may be coupled to the controller 105 of the induction system to operate features of the cooktop apparatus 100. For example, the user may adjust the cooking surface 102 temperature by choosing to increase/decrease power output of the removable battery 104 via the rotary encoders (e.g., knobs or dials). As another example, the user may select cooking preset conditions on the user interface such as “rapid boil,” “keep warm,” “simmer,” and other pre-programmed conditions intended to cook or boil substances on the cooktop apparatus 100. As another example, the controller 105 may include a circuit configured to automatically turn off powered components (e.g., induction coils, fans, etc.) of the cooktop apparatus 100 after the apparatus remains idle for a designated time period.

In some embodiments, the user interface 114 may take the form of a mobile application compatible with a smartphone, tablet, laptop, or other smart device. Accordingly, in some embodiments, the cooktop apparatus 100 comprises a wireless communication device configured to interact with the aforementioned devices. For example, the user may interact with the cooktop apparatus 100 via selecting actions on a smart device. The controller may include a circuit configured to communicate with external devices via NFC, Bluetooth, or Wi-Fi transceivers. As another example, the user may monitor battery life, cooking surface 102 temperature, and other metrics from a smart device configured to communicate with the cooktop apparatus 100.

### Additional Components

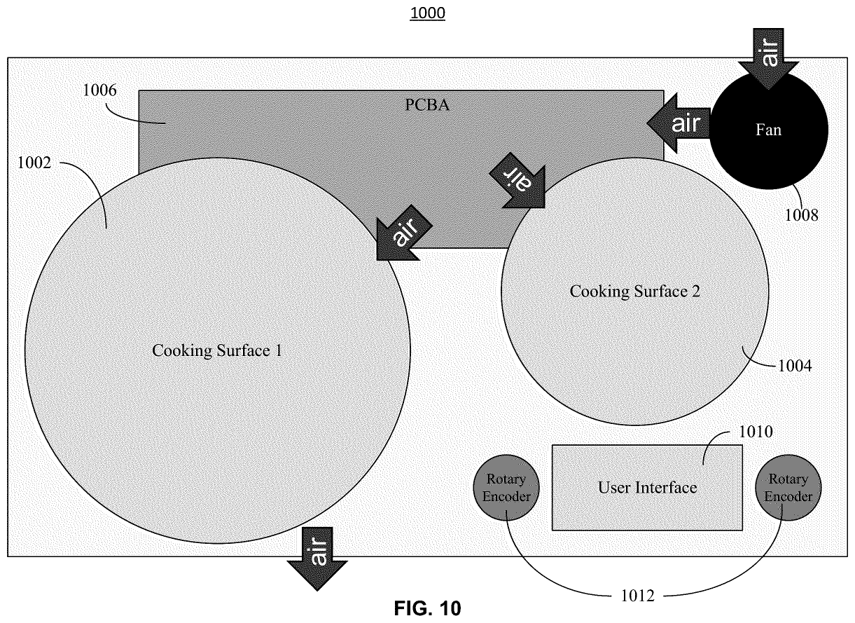

Referring again to FIG. 1, the cooktop apparatus 100 may include additional components to prevent overheating of the cooktop apparatus 100. In some embodiments, the induction system may include active cooling systems (e.g., one or more fans, see FIG. 10) to induce airflow, transferring heat away from the controller 105 of the induction system. For example, the induction system may include active cooling systems including, but not limited to, axial fans, centrifugal fans, and crossflow fans. In some embodiments, the induction system may include one or more heat sinks adjacent to the induction coil 103, the cooking surface 102, and/or the batter pack 104 to dissipate heat generated during operation. For example, the induction system may include one or more extruded heat sinks, bonded fin heat sinks, stamped fin heat sinks, forged heat sinks, folded fin heat sinks, active heat sinks, or similar devices.

### Operation of Induction System

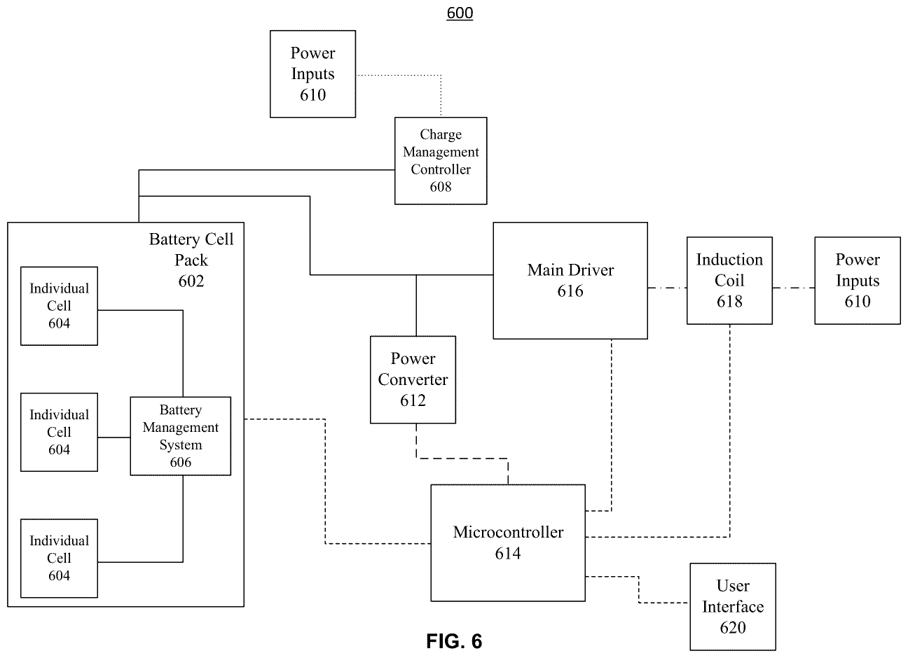

Referring now to FIG. 6, the cooktop apparatus may comprise circuitry 600 configured to distribute and manage power to one or more induction coils. In some embodiments, the cooktop apparatus comprises a single cell or multi-cell battery cell pack 602. The battery cell pack 602 may be removably installed into the unit. The battery cell pack 602 may consist of individual cells 604 configured in series and/or in parallel to achieve the desired output power. The individual cells 604 may be monitored or balanced by a battery management system 606 to protect the battery pack from overvoltage, overcurrent, cell imbalance, over-temperature, under-temperature, or other fault conditions. For example, the battery cell pack 602 may include five cells in parallel configured into sets with sixteen sets in series.

The battery cell pack 602 may be charged with a charge management controller 608. The charge management controller 608 may be located within the housing or may be located in an external charger. The charge management controller 608 may deliver energy to the battery cell pack 602 using a constant current and/or constant voltage charge profile. The charge management controller 608 may have a power input 610 such as AC line voltage, rectified power from an AC line voltage source, 12V battery from a vehicle battery, solar panel, USB, or other electrical power source. The power input(s) 610 may have a hierarchical design, wherein (by way of non-limiting example) the primary power source may be the AC power, the secondary source may be a solar panel, the third priority source may be USB source, and the fourth priority may be a vehicle battery. A power multiplexer may be used to configure and control the priority of power source selection.

The output of the charge management controller 608 may connect to the battery cell pack 602. The output of the charge management controller 608 may also connect to the main driver 616. The charge management controller 608 may disable charging when power is drawn from the battery pack for induction cooking. Alternatively, the charge controller may deliver a metered amount of power to the main power bus. The power may be sufficient for the induction power system or may supplement power from the battery cell pack 602 to the induction system.

A power converter 612 may convert the main bus voltage to a different voltage for internal systems such as the microcontroller 614. For example, the power converter 612 may convert from an 80-100V main bus voltage to a 3.3V supply for the microcontroller 612. The main driver 616 may energize the induction coil 618 used to deliver induction power to the cookware. A sensor or set of sensors may connect to the induction coil 618, main driver 616, or power signals in between. The sensors may monitor voltage, current, temperature, phase angle, or magnetic field of the induction power delivery. The microcontroller 614 may monitor battery status such as voltage and remaining capacity through the communication bus (shown in dashed line for communication and measurement signals). The microcontroller 614 may also monitor and communicate with the user interface 620. For example, when a user activates the unit through the user interface 620, the microcontroller 614 may provide signals to the main driver 616 to activate energy to the induction coil 618. The microcontroller 614 may monitor feedback from the sensors and battery cell pack 602 along with the user interface 620 to control the system.

The user interface 620 may include a rotary encoder, mechanical buttons, capacitive touch buttons, a display with/without an integrated touchscreen, indicator lights and graphics, audible feedback such as a speaker, vibration motor for haptic feedback, or any combination thereof. The battery cell pack may incorporate the charge management controller 608 and power inputs 610. The battery cell pack 602 may also incorporate a power converter 612 for an auxiliary output power such as a USB (e.g., USB-A, USB-C) or 12V power output.

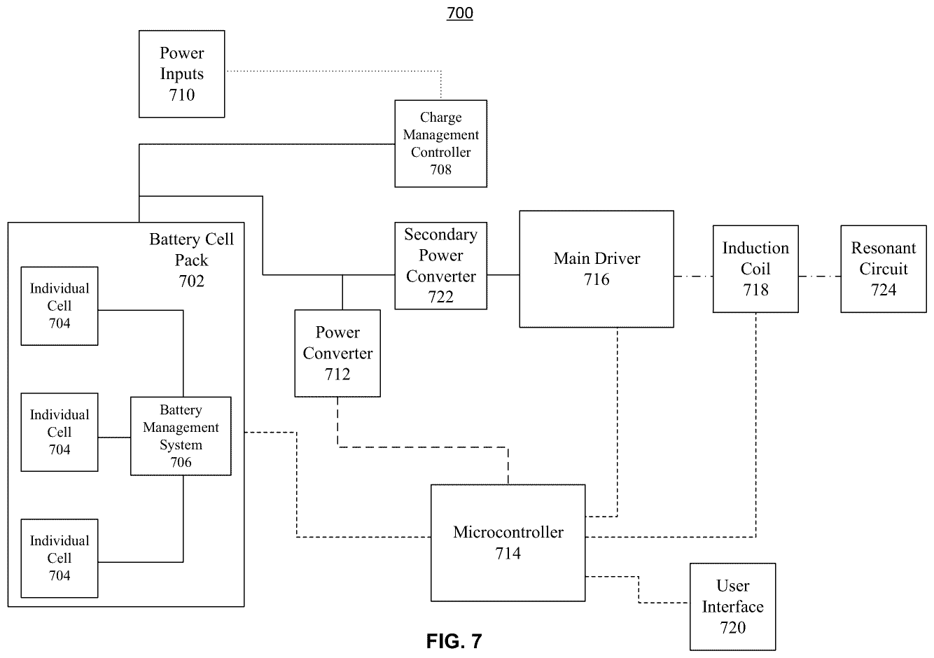

Referring to FIG. 7, the cooktop apparatus may include power management circuitry 700 configured to supply power to an induction coil 718 using a secondary power converter 722. The secondary power converter may compensate variations in the battery cell pack 702 and main power converter 712. The secondary power converter 722 may increase the voltage delivered to the driver 716, decrease the voltage, or target a constant voltage within the minimum and maximum range of the battery pack output. The circuitry may include an induction coil 718 configured as a resonant circuit 724 using at least one capacitor and one inductor. In some embodiments, the resonant circuit 724 may be a series resonant circuit, parallel resonant, or any combination of resonant configurations.

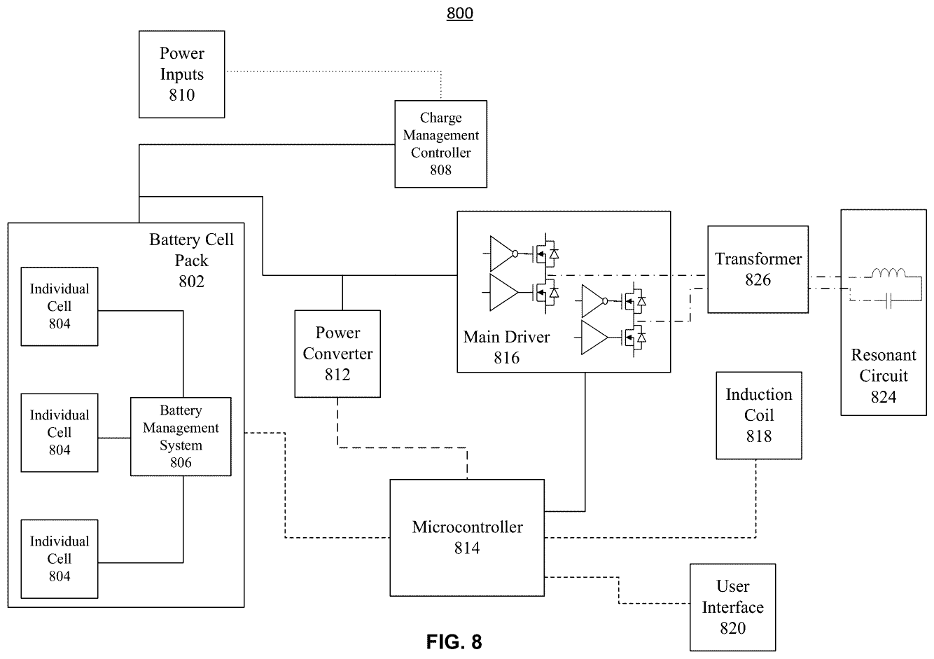

Referring to FIG. 8, the cooktop apparatus may include power management circuitry 800 configured to supply power to an induction coil 818 using a transformer 826 disposed between a power driver 816 and an induction resonant circuit 824. In some embodiments, the power management circuitry includes a power driver 816 comprising a full bridge driver using four power switches (shown in FIG. 8 as MOSFETs). The power driver 816 may convert DC voltage from the battery cell pack 802 to an AC voltage that may transmit to a transformer 826. The transformer may increase the voltage transmitted to the induction resonant circuit 824.

In some embodiments, the voltage from the battery cell pack 802 may be insufficient for the power driver 816 to directly power the induction resonant circuit 824. By utilizing the transformer 826, a simple and low-cost power conversion may be achieved as an alternative to a regulated power converter (e.g., shown in FIG. 7). For example, a 48V battery pack may have sufficient output power to provide 2.5 k W of induction energy; however, the lower voltage of the battery pack combined with a high-inductance induction power coil may limit the amount of current that may be generated by the power driver 816. Through application of a full-bridge driver 816 combined with a transformer 826, the system 800 may convert from lower voltage and higher current at the battery cell pack 802 to higher voltage and lower current at the induction coil 818.

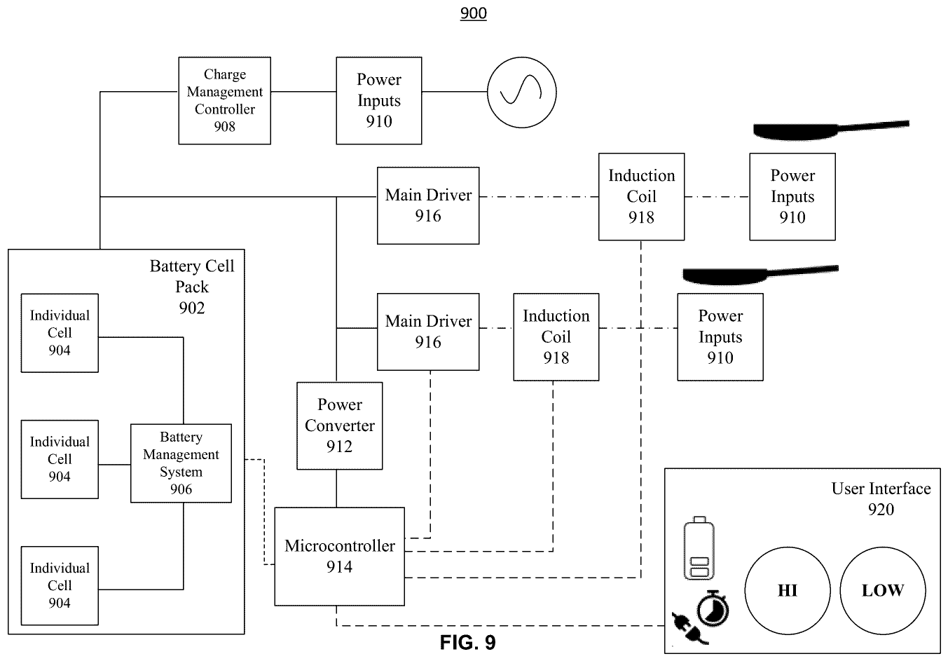

Referring to FIG. 9, the user interface 920 of the cooktop apparatus may display various conditions of the cooktop apparatus related to power management, battery life, and cooktop conditions. For instance, as shown in FIG. 9, the user interface 920 may display the output for two different induction coils (e.g., “HI” and “LOW”), along with battery life remaining, time remaining for the battery at current cooktop conditions, and whether additional power inputs are being used in addition to the battery.

In some embodiments, the heating system comprises an induction system, a battery system, and (optionally) a solar system comprising solar panels. The induction system may include a controller, a thermocouple, a cooking surface, and a display. The battery system may include a battery pack and a charging module.

The battery pack and the solar panels may supply voltage to the charging module. The charging module may supply limited voltage the battery pack to recharge the battery system. When in operation, the controller may receive charge directly from the removable battery pack (via supplying voltage) or the solar panels (via daylight detection). In some embodiments, the controller may receive charge from charging module. The controller may supply a signal to the induction system dependent on an input received from the user interface. The voltage may power the induction coil, leading to resistive heating in an inductive cookware container on the cooking surface, thereby heating liquids or food items in the cookware and causing the temperature of the cooking surface to increase.

A thermocouple may detect the temperature of the cooking surface and deliver a temperature reading to the controller. The controller may transmit the temperature reading to the display of the user interface. The display may then present the temperature value of the cooking surface to the user or extrapolate the temperature of the food item or beverage in the cookware and report that temperature to the user. The user may then elect whether to adjust the system power output using, e.g., rotary encoders.

FIG. 10 shows an embodiment using airflow to cool the internal components of a cooktop apparatus 1000 equipped with a first cooking surface 1002 and a second cooking surface 1004, each disposed above an induction coil (not shown). A fan 1008 may propel air away from the power electronics (e.g., PCBA 1006). The air may then flow over warm components of the cooktop apparatus such as the induction coil below the first cooking surface 1002 and/or the induction coil below the second cooking surface 1004. Air may be directed out of the cooktop apparatus without heating any additional components such as the components corresponding to the user interface 1010 or rotary encoders 1012 (e.g. knobs, switches, buttons, or similar components). In some embodiments, air may flow from the back of the unit near the battery and exhaust out the front of the cooktop apparatus. In some embodiments, air may flow from the back of the unit near the battery and exhaust out the bottom near the front of the cooktop apparatus. In some embodiments, air may flow from the sides of the unit towards the back, bottom, or front of the cooktop apparatus, though exhausting hot air out the front of the apparatus should be avoided because it may present a hazard or discomfort to the user. The cooktop apparatus 1000 may dissipate hot air in the above embodiments to prevent damage to the battery pack. The cooktop apparatus 1000 may dissipate hot air in the above embodiments to prevent the blockage of airflow when the cooktop apparatus 1000 is placed on a soft or uneven surface.

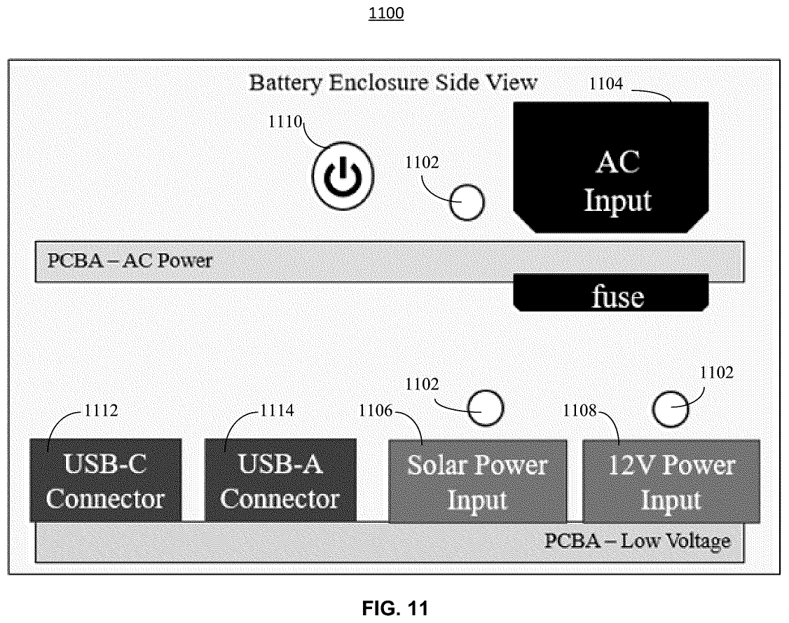

Referring to FIG. 11, a side panel of and embodiment of the removable battery pack 1100 includes indicator lights 1102 configured to communicate the power source(s) from which the system is drawing power. In some embodiments, the side panel of the removable battery pack 1100 may include indicator lights 1102 configured to communicate whether any system errors may be present. For example, if the cooktop apparatus may extract power from multiple power sources (e.g. an AC input 1104, a solar power input 1106, and/or a 12V power input 1108), a light of a particular color (e.g., green) may indicate power sourced from that input. A light of a different color (e.g., yellow) may indicate a secondary power input from which power is not drawn. In some embodiments, errors may occur when insufficient power is available or excessive voltage is detected. For example, an aging solar panel may apply sufficient voltage when power is drawn, but as power is drawn from the panel, the voltage may drop excessively (e.g., below 5V), indicating a damaged or underpowered panel. In this scenario, the indicator 1102 may emit light of a predetermined color (e.g., red).

In some embodiments, the side panel of the removable battery pack 1100 may include a switch 1110 configured to turn on USB power from the removable battery pack 1100 to charge external devices. In the event no USB devices are connected, the controller may turn off power to the USB ports to conserve charge. The switch 1110 may allow power to the USB interface until turned off. The switch 1110 may include a momentary button that temporarily applies power to the USB interface. If a device is detected, the USB interface may remain in the on state, allowing power to be transmitted to the USB device via the USB-A connector 1112 and/or USB-C connector 1114.

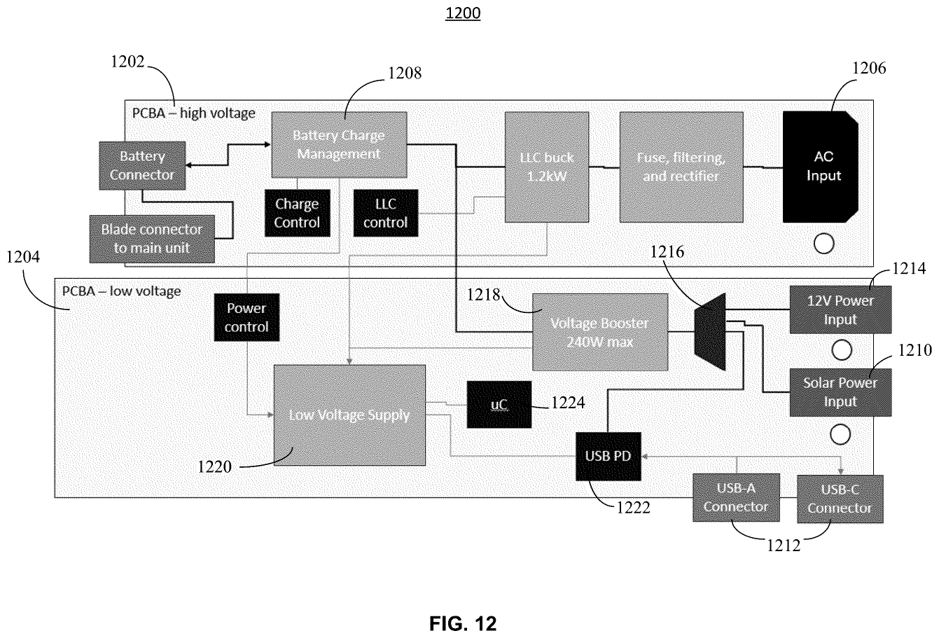

FIG. 12 shows a functional block diagram 1200 of two separate printed circuit board assemblies (e.g., PCBAs) within the removable battery pack. In some embodiments, power connections are shown with solid, dark-colored lines and signaling connections are shown with solid, light-colored lines. In some embodiments, the removable battery pack may include two PCBAs: a high voltage PCBA 1202 and a low voltage PBCA 1204. The removable battery pack may include two, separate PCBAs constructed to isolate high voltage electronics, which may require extra precautions for component spacing from low voltage electronics.

The high voltage PBCA 1202 may filter the AC input 1206 to protect the system from transients, convert the power to high voltage DC, and then provide the high voltage DC to the battery charge manager 1208. The battery charge manager 1208 may convert the high voltage DC into a regulated power output optimized for battery charging.

The low voltage PCBA 1204 may select power inputs for solar charging 1210, USB charging (via a USB-A and/or USB-C connector) 1212, and 12V vehicle battery charging 1214 using a power multiplexer 1216. The low voltage PCBA 1204 may then transmit the power inputs to a voltage converter. In some embodiments, the voltage booster (e.g. voltage converter) 1218 may boost the voltages from the selected input to voltage at or above the removable battery pack and provide the voltages to the battery charge manager 1208. The voltage booster 1218 may provide a maximum of 240 W of power (e.g. portable solar panels may provide up to 240 W, USB-C may provide up to 240 W, and 12 V vehicle power bus may provide up to 120 W).

In some embodiments, the low voltage supply 1220 may convert the power available from the removable battery pack or AC input 1206 to voltage levels that the USB power outputs 1222 and the onboard microcontroller (e.g., uC) 1224 may utilize. The onboard microcontroller 1224 may operate when the user turns on the power output of the removable battery pack, at which point charge status indication and USB power are available. The removable battery pack may disable the power output after a predetermined time period to reduce the energy consumption of the removable battery pack to provide long-term charge storage.

### System Capabilities

In some embodiments, a user may heat a liquid or food item with the disclosed cooktop apparatus. The user may turn on power the cooktop apparatus through an input (e.g., a tactile button) on the user interface. The cooktop apparatus may communicate via the display of the user interface information regarding the battery performance, preset power output of the cooking surface, and additional options to operate the apparatus. The user may choose to heat a liquid or food item by placing a vessel containing a liquid or a food item on the cooking surface. The user may then adjust the power output of the cooktop using, e.g., rotary encoders of the user interface or the touchscreen display. The cooktop apparatus may then increase/decrease temperature based on the input given by the user, allowing for appropriate heating of the liquid or food item.

In some embodiments, the cooktop apparatus may include an induction system configured to heat water at a rate sufficient to boil one cup of water in 150 seconds or less, 140 seconds or less, 130 seconds or less, 120 seconds or less, 110 seconds or less 105 seconds or less, 100 seconds or less, 90 seconds or less, 85 seconds or less, 80 seconds or less, 75 seconds or less, 70 seconds or less, 65 seconds or less, 60 seconds or less, or any range or value between and/or including any two of these values. The above-referenced boiling times refer to the amount of time required to heat one cup of water from ambient temperature (e.g., 20° C., 21° C., 22° C., 23° C., 24° C., or 25° C.) to boiling temperature at sea level.

In some embodiments, the cooktop apparatus permits at least 1 hour, at least 1.25 hours, at least 1.5 hours, at least 1.75 hours, at least 2 hours, at least 2.5 hours, at least 3 hours, or longer, of cooking time before requiring battery recharge or replacement.

### Portable Heating Apparatus

In another aspect, the present disclosure relates to a portable, battery-powered vessel (hereafter “portable vessel” or “portable heating apparatus”). One advantageous feature of the portable heating apparatus is that the portable heating apparatus is configured with a removable battery pack capable of being recharged with solar panels, which may reduce carbon emissions into the environment. The portable heating apparatus has the advantage of being shaped like a thermos (having an approximately cylindrical shape with a circular or approximately circular footprint), making it easily transportable for backpacking, hiking, etc.

### Container

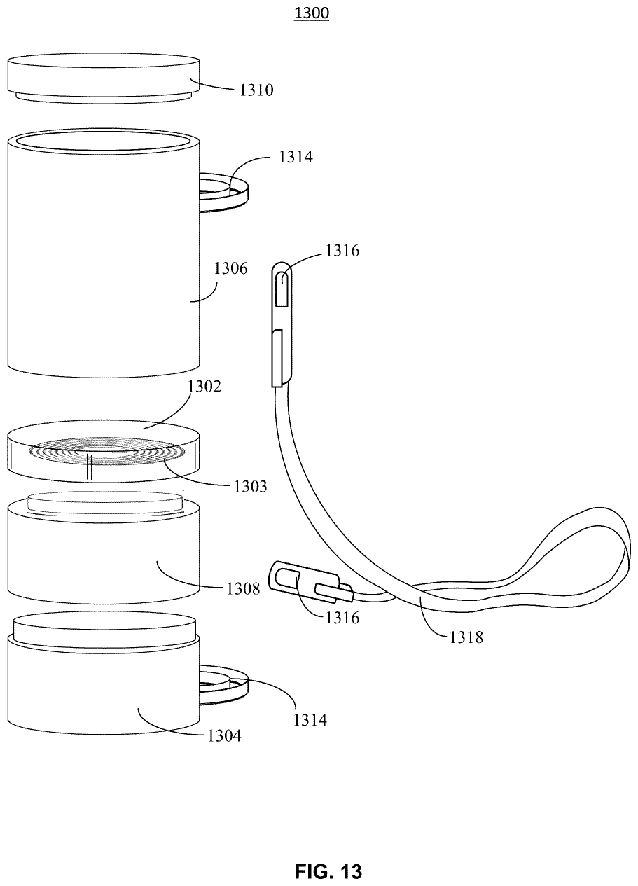

Referring to FIG. 13, the portable heating apparatus 1300 comprises a container 1306 configured to contain a food item (e.g., soup) or liquid (e.g., water). In some embodiments, the container 1306 comprises any material suitable for induction cookware, permitting induction heating of the container and the contents therein. For example, in some embodiments, the container 1306 comprises stainless steel, carbon steel, cast iron, or any other material suitable for induction heating. In some embodiments, the container 1306 is thermally insulated, such that the user can safely handle the container 1306 after heating while the food item or liquid therein is at an elevated temperature.

The container 1306 is designed hold liquids and/or compatible food items (e.g. soup). The housing may have the capability of holding between 0.5 to 4 cups of liquid, between 1 to 3.5 cups of liquid, between 1.5 to 3.5 cups of liquid, between 2 to 3 cups of liquid, or any range or value including and/or between any two of these values. In some embodiments, the container 1306 may be removable (e.g. screws off via threads or clips on to the apparatus) and detach from the system.

In some embodiments, the portable heating apparatus 1300 may comprise a lid 1310 configured to cover at least a portion of the housing designated to hold liquids or food items to protect the system from spillage or environmental contaminants. The lid 1310 may attach to the housing via any suitable component (e.g., one or more hinges). In some embodiments, the portable heating apparatus 1300 may include a lid 1310 configured to function as a cover for the container 1306 designated to hold liquids or cover the cooking surface 1302 to protect the induction system from physical damage. In some embodiments, the container 1306 comprises a lid 1310, which may fit onto the container 1306 via one or more hinges, threads, clips, magnets, or by push fitting onto the container 1306.

### Cooking Surface

Referring still to FIG. 13, a portable heating apparatus 1300 according to the present disclosure includes a cooking surface 1302 where a container (e.g., induction cookware) may be placed and held in position in proximity to an induction coil, such that the induction coil is able to induce sufficient electric current in the container 1306 to heat it. The cooking surface 1302 may comprise any suitable heat-resistant, electrically insulating material (e.g., ceramic, glass, heat-resistant polymers, or combinations thereof).

The cooking surface 1302 may be any suitable shape for accommodating induction cookware and guiding the user to place the cookware in proximity to an induction coil 1303, such that the induction coil 1303 may induce sufficient electric current in the container to heat it. Although not intended to be limiting, the cooking surface 1302 may be circular, square, rectangular, or polygonal in shape. In some embodiments, the portable heating apparatus 1300 comprises a cooking surface 1302, which is circular in shape and has a diameter of 3 to 6 (e.g., 3, 3.5, 4, 4.5, 5, 5.5, or 6 inches).

### Removable Battery Pack

Referring still to FIG. 13, the portable heating apparatus 1300 may include a removable battery pack 1304 configured to power the portable heating apparatus 1300, and in particular the induction coil 1303. Although not intended to be limiting, in some embodiments, the removable battery pack 1304 is removably coupled to the cooking surface 1302 or other components of the portable heating apparatus 1300 via threads, push fitting, and/or a charging connector that is pushed into place to establish an electrical connection to an induction system contained within housing 1308 (e.g., similar to charging connectors used for battery-powered handheld tools). In some embodiments, the removable battery pack 1304 attaches to the bottom of the portable heating apparatus 1300, on a side opposite the cooking surface 1302, by detent(s), clip(s), or by screwing into the housing 1308, so long as means are provided for establishing an electrical connection between the battery pack and an induction system contained within the housing 1308. The removable battery pack 1304 may comprise a lithium-ion battery. In some embodiments, the removable battery pack may comprise a lithium-ion battery. In some embodiments, the removable battery pack may comprise a lithium-iron phosphate (LiFePO₄) battery, lithium manganese oxide (LiMn₂O₄) battery, lithium nickel manganese cobalt oxide (NMC) battery, lithium nickel cobalt aluminum oxide (NCA) battery, lithium titanate (LTO) battery, or sodium-iron-phosphate battery. In some embodiments, the removable battery pack 1304 is a solid-state battery or a lead-acid battery.

In some embodiments, the removable battery pack 1304 may has a 48V 20 Ah 1 kw capacity with 55-amp continuous current and 60-amp peak current.

The removable battery pack 1304 may have any suitable input power to power one or more induction coils 1303. In some embodiments, the removable battery has an input power of 40 W to 2500 W, 100 W to 2000 W, 200 W to 1500 W, or 500 W to 1000 W. In some embodiments, the removable battery pack 1304 has a capacity of 1500 Wh.

In some embodiments, the removable battery pack 1304 has a maximum power of less than or equal to about 2500 W, less than or equal to about 2400 W, less than or equal to about 2300 W, less than or equal to about 2200 W, less than or equal to about 2100 W, less than or equal to about 2000 W, less than or equal to about 1900 W, less than or equal to about 1800 W, less than or equal to about 1700 W, less than or equal to about 1600 W, less than or equal to about 1500 W, or any range or value including and/or between any two of these values. In some embodiments, the removable battery pack 1304 has a maximum power of greater than or equal to about 1000 W, greater than or equal to about 1000 W, greater than or equal to about 1100 W, greater than or equal to about 1200 W, greater than or equal to about 1300 W, greater than or equal to about 1400 W, greater than or equal to about 1500 W, greater than or equal to about 1600 W, greater than or equal to about 1700 W, greater than or equal to about 1800 W, greater than or equal to about 1900 W, greater than or equal to about 2000 W, greater than or equal to about 2100 W, greater than or equal to about 2200 W, greater than or equal to about 2300 W, greater than or equal to about 2400 W, greater than or equal to about 2500 W, or any range or value including and/or between any two of these values.

In some embodiments, the removable battery pack 1304 may operate for at least 500 cycles, at least 600 cycles, at least 700 cycles, at least 800 cycles, at least 900 cycles, or at least 1000 cycles before replacement.

In some embodiments, the removable battery pack 1304 may include a high-power battery charging IC (e.g., from Texas Instruments) configured to manage input power of the portable heating apparatus 1300. The IC may receive power from additional ports connected to the removable battery pack 1304. The additional ports may include one or more of a rectified AC, solar, 12 V DC, and/or USB port. The additional ports may transmit the energy to a voltage converter inside the removable battery pack 1304 to charge the battery pack 1304.

In some embodiments, the removable battery pack 1304 is configured to charge with external devices (e.g., solar panels). For example, the portable heating apparatus 1300 may be equipped with solar panels or may be configured to interface with exterior renewable energy generators, 110 V electrical outlets, or 12 V vehicle outlets. In some embodiments, the removable battery pack 1304 may be removed from the portable heating apparatus 1300 to serve as a mobile power bank. For example, the removable battery pack 1304 may be capable of charging and/or powering external electronic devices, outdoor recreation accessories, or other similar products.

### Solar Panels

Referring still to FIG. 13, the portable heating apparatus 1300 may include one or more solar panels (not shown) coupled to the removable battery pack 1304 to supply power to the system. The portable heating apparatus 1300 may include rigid, flexible, or a combination of rigid and flexible solar panels. For example, the portable heating apparatus 1300 may include rigid solar panels such as, but not limited to, monocrystalline silicon solar panels, polycrystalline silicon solar panels, amorphous silicon (a-Si) solar panels, cadmium telluride (CdTe) solar panels, copper indium gallium selenide (CIGS) solar panels, or any combination thereof. In some embodiments, the solar panels 1312 comprise flexible solar panels such as a-Si flexible solar panels, CIGS flexible solar panels, organic photovoltaic (OPV) flexible solar panels, perovskite flexible solar panels, thin-film crystalline silicon flexible solar panels, or any combination thereof. In some embodiments, the solar panels are flexible solar panels.

In some embodiments, the solar panels are configured to retract into the housing 1308 of the portable heating apparatus 1300. In some embodiments, the solar panels have the same shape as the footprint of the portable heating apparatus 1300, such that the solar panels may be adjoined to the housing 1308 about a common axis (e.g., via a pin) and are configured to rotate outward such that the solar panels “fan out” outside the footprint of the portable heating apparatus 1300 and retract into the footprint of the portable heating apparatus 1300. In some embodiments, the solar panels may be slidably coupled to one another, such that the solar panels telescope outside the footprint of the portable heating apparatus 1300 and retract into the portable heating apparatus 1300. Accordingly, the solar panels may be exposed to the sunlight when needed to charge the removable battery pack 1304 and retracted when not in use, such that they are protected from damage by the housing 1308 of the portable heating apparatus 1300.

In some embodiments, the solar panels have a power rating of about 40 W to about 250 W, about 50 W to about 200 W, about 100 W to about 150 W, or any range or value including and/or between any two of these values. In some embodiments, the solar panels 1312 have a power rating of at least about 40 W, at least about 50 W, at least about 60 W, at least about 70 W, at least about 80 W, at least about 90 W, at least about 100 W, 110 W, at least about 120 W, at least about 130 W, at least about 140 W, at least about 150 W, at least about 160 W, at least about 170 W, at least about 180 W, at least about 190 W, at least about 200 W, at least about 210 W, at least about 220 W, at least about 230 W, at least about 240 W, at least about 250 W, or any range or value including and/or between any two of these values. In some embodiments, the solar panels may have a total weight from about 5 lbs. to about 30 lbs.

### Induction System

Referring still to FIG. 13 the portable heating apparatus 1300 may include an induction system connected to the removable battery pack 1304. The induction system may include an induction coil 1303 and a controller configured to facilitate power transfer from the removable battery pack 1304 to the induction coil 1303. The induction system may include additional components such as one or more fans, one or more heat sinks, or other heat dissipation devices to improve the performance of the portable heating apparatus 1300.

### Induction Coil

The induction system comprises an induction coil 1303 located adjacent to the cooking surface 1302. In some embodiments, the induction coil 1303 comprises copper. In some embodiments, the induction coil 1303 comprises ferrite materials to enhance electromagnetic field generation and reduce eddy current losses. In some embodiments, the ferrite materials comprise “soft” ferrite materials comprising manganese-zinc (MnZn) or nickel-zinc (NiZn) compounds. In some embodiments, laminated iron or steel sheets may be used in conjunction with ferrite materials to promote and/or enhance magnetic field generation. In some embodiments, the induction coil 1303 comprises an electrically insulating and/or thermally insulating coating comprising, e.g., a ceramic, a glass, a high-temperature resistant polymer (e.g., a polyimide) to provide electrical insulation for the induction coil 1303 and prevent short circuits.

### Controller

The induction system comprises a controller (not shown) to control power supply from the battery 1304 to the induction coil 1303. In some embodiments, the controller comprises a circuit configured to facilitate power transfer from the removable battery pack 1304 to the induction coil. The controller may be contained within the housing 1308. The circuit of the controller may include one or more processors configured to control and/or monitor the battery. The processor(s) may be or include any device, component, element, or hardware designed or configured to perform the various steps recited herein. For example, the processor(s) may include any number of general-purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof, designed or configured to perform the various steps recited herein. In some embodiments, the processor(s) may be coupled to memory configured to store data for system processing and performance. In some embodiments, the circuit comprises one or more sensors configured and/or arranged to sense various conditions of the portable heating apparatus 1300. For example, in some embodiments, the sensor(s) may include any number of voltage sensors, current sensors, temperature sensors, cookware/container detection sensors (e.g., inductive or capacitive sensors), position and/or proximity sensors (e.g., capacitive touch or infrared proximity sensors), load sensors, or any combination thereof configured or arranged to sense various conditions recited herein.

The controller may facilitate power transfer from the removable battery 1304 to the induction coil 1303 using the one or more processors, memory, or one or more sensors of the circuit. For example, the controller may communicate with the removable battery 1304 to increase or decrease power output to the induction coil to achieve a desired temperature set on the portable heating apparatus 1300. The temperature sensors of the circuit (e.g., thermocouple) may transmit a temperature reading of the induction coil 1303 to the controller. The controller then via the one or more processors may prompt the charging module to adjust power output according to the desired temperature. As another example, the controller may include a circuit configured to automatically turn off the portable heating apparatus 1300 after remaining idle for a designated period. In some embodiments, the controller may include a circuit configured to complete actions such as calibrate power of the portable heating apparatus 1300, immediately shut of the system fan(s), reduce noise after the system reaches a set decibel level, and other functions.

### Housing

Referring still to FIG. 13, the portable heating apparatus 1300 comprises a housing 1308 surrounding at least a portion of the induction system and disposed below the induction coil 1303. The housing 1308 provides an insulative barrier to protect the user from the internal electrically conductive and thermally conductive components therein. The housing 1308 also mitigates the introduction of dust or debris that may cause damage to the components of the portable heating apparatus 1300. Moreover, the housing 1308 serves to contain the components of the portable heating apparatus 1300 in a manner that permits easy transportation and use without the need for assembly on site.

### User Interface & Display

In some embodiments, the portable heating apparatus 1300 comprises a rotary encoder (not shown) to adjust power output and thereby cooking temperature of the portable heating apparatus 1300. The rotary encoders may convert rotational position or motion into a digital signal, which may allow users to quickly scroll through system options (e.g., output power to the induction coil) or to select from various heating programs stored in memory. For instance, the user may select cooking preset conditions on the rotary encoder such as “rapid boil”, “keep warm,” “simmer,” and other pre-programmed conditions intended to cook or boil substances on the portable heating apparatus 1300. As another example, the controller may include a circuit configured to automatically turn off the portable heating apparatus 1300 after remaining idle for a designated time period.

In some embodiments, the user interface may take the form of a mobile application compatible with a smartphone, tablet, laptop, or other smart device. Accordingly, in some embodiments, the portable heating apparatus 1300 comprises a wireless communication device configured to interact with the aforementioned devices. For example, the user may interact with the portable heating apparatus 1300 via selecting actions on a smart device. The controller may then include a circuit configured to communicate with external devices via NFC, Bluetooth, or Wi-Fi transceivers. As another example, the user may monitor battery life, cooking surface 1302 temperature, and other metrics from a smart device configured to communicate with the portable heating apparatus 1300.

### Additional Components

The portable heating apparatus may include additional components to prevent overheating of the portable heating apparatus 1300. In some embodiments, the induction system may include active cooling systems (e.g., one or more fans) to induce airflow transferring heat away from the controller of the induction system. For example, the induction system may include active cooling systems including, but not limited to, axial fans, centrifugal fans, and crossflow fans. In some embodiments, the induction system may include one or more heat sinks adjacent to the induction coil 1303, the cooking surface 1302, and/or the battery pack 1304 to dissipate heat generated during operation. For example, the induction system may include one or more extruded heat sinks, bonded fin heat sinks, stamped fin heat sinks, forged heat sinks, folded fin heat sinks, active heat sinks, or similar devices.

In some embodiments, the portable heating apparatus 1300 comprises one or more rings 1314 to facilitate coupling to clips 1316 (e.g., attached to a strap 1318) to permit easy transport of the portable heating apparatus 1300. In some embodiments, the portable heating apparatus 1300 comprises a self-leveling base capable of being adjusted to permit level placement of the portable heating apparatus 1300 on uneven surfaces. In some embodiments, the portable heating apparatus 1300 may comprise a leveling tool (e.g., a bubble level embedded in the housing) to assist users in leveling the cooktop apparatus 100 on uneven surfaces.

### System Capabilities

In some embodiments, a user may heat a liquid or food item with the disclosed portable heating apparatus 1300. The user may turn on power the cooktop apparatus through an input (e.g., a tactile button) on the user interface. The portable heating apparatus 1300 may communicate via the display of the user interface information regarding the battery performance, preset power output of the cooking surface, and additional options to operate the apparatus. The user may choose to heat a liquid or food item by placing a container containing a liquid or a food item on the cooking surface 1302. The user may then adjust the power output of the portable heating apparatus 1300 using, e.g., rotary encoders of the user interface or a touchscreen display. The portable heating apparatus 1300 may then increase/decrease temperature based on the input given by the user, allowing for appropriate heating of the liquid or food item.

In some embodiments, the portable heating apparatus 1300 may include an induction system configured to heat water at a rate sufficient to boil one cup of water in 150 seconds or less, 140 seconds or less, 130 seconds or less, 120 seconds or less, 110 seconds or less 105 seconds or less, 100 seconds or less, 90 seconds or less, 85 seconds or less, 80 seconds or less, 75 seconds or less, 70 seconds or less, 65 seconds or less, 60 seconds or less, or any range or value between and/or including any two of these values. The above-referenced boiling times refer to the amount of time required to heat one cup of water from ambient temperature (e.g., 20° C., 21° C., 22° C., 23° C., 24° C., or 25° C.) to boiling temperature at sea level.

The portable cooktop apparatus and/or portable heating apparatus disclosed herein provide a portable, environmentally friendly option for preparing meals and beverages outdoors or in areas without conventional cooking appliances. The cooktop apparatus and/or vessel do not generate carbon monoxide or carbon dioxide and functions without use of an open flame. The use of induction technology allows the cooktop to provide safe cooking methods for users in a forest setting or in dry terrain. Additionally, in the event the removable battery pack may be replaced, the pack can be recycled or upcycled, such that no part of the cooktop apparatus or portable vessel may reach a landfill.

### Definitions

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that some embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the cooktop apparatus or portable heating apparatus as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A portable, battery-powered induction cooktop apparatus comprising:
a cooktop comprising a cooking surface;
a removable battery;
an induction system connected to the removable battery, the induction system comprising:
an induction coil located adjacent to the cooking surface; and
a controller, wherein the controller comprises a circuit configured to facilitate power transfer from the removable battery to the induction coil; and
a housing surrounding at least a portion of the induction system, wherein the housing comprises a lid configured to cover at least a portion of the cooktop.

2. The apparatus of claim 1, wherein the cooktop comprises two cooking surfaces.

3. The apparatus of claim 1, wherein the removable battery is connected to one or more solar panels.

4. The apparatus of claim 1, where in the apparatus further comprises wind guards.

5. The apparatus of claim 1, further comprising a handle or a removable strap connected to the housing.

6. The apparatus of claim 1, wherein the apparatus is capable of boiling 1 cup of water in 90 seconds or less.

7. The apparatus of claim 1, wherein the lid comprises an integrated cutting board.

8. The apparatus of claim 1, wherein the removable battery has an input power of 40 W to 2500 W.

9. The apparatus of claim 1, wherein the controller comprises a rotary encoder configured to adjust power delivered by the induction system.

10. The apparatus of claim 1, wherein the removable battery has a capacity of 1500 W or a maximum power of up to 2500 W.

11. The apparatus of claim 1, wherein the battery is a solid-state battery, lithium-sulfur battery, silver oxide battery, lithium-ion battery, sodium-ion battery, or iron-air battery.

12. The apparatus of claim 1, wherein the removable battery is connected to one or more AC ports, DC ports, USB ports, or combinations thereof.

13. The apparatus of claim 3, wherein the one or more solar panels comprises a flexible solar panel.

14. The apparatus of claim 3, wherein the one or more solar panels has a charging rate of 40 W to 250 W.

15. The apparatus of claim 1, wherein the induction system comprises a wireless communication device.

16. A method for heating a food item or liquid using the apparatus of claim 1, the method comprising:
contacting a vessel containing the food item or liquid with the cooking surface; and
operating the induction system to heat the food item or liquid.

17. The method of claim 16, wherein the food item or liquid is water and the operating heats the water at a rate sufficient to boil one cup of water in 90 seconds or less.

18. A portable heating apparatus, comprising:
a container configured to contain a liquid to be heated;
a removable battery;
an induction system connected to the removable battery, wherein the induction system comprises:
an induction coil located adjacent to the vessel; and
a controller, wherein the controller comprises a circuit configured to facilitate power transfer from the removable battery to the induction coil;
a housing surrounding at least a portion of the induction system; and
one or more solar panels connected to the removable battery.

19. The portable heating apparatus of claim 18, wherein the battery is a solid-state battery, lithium-sulfur battery, silver oxide battery, lithium-ion battery, sodium-ion battery, or iron-air battery.
